(19) United States
(12) Patent Application Publication
(10) Pub. No.: US 2023/0279273 A1
(43) Pub. Date: Sep. 7, 2023

(54) PROTECTION SHEET AND LAMINATE BODY

(71) Applicant: KEIWA INCORPORATED, Chuo-ku (JP)

(72) Inventors: Takahiro TSUJI, Tokyo (JP); Kazushi MATSUMOTO, Tokyo (JP)

(73) Assignee: KEIWA INCORPORATED, Chuo-ku (JP)

(21) Appl. No.: 17/998,826

(22) PCT Filed: Jun. 7, 2021
(86) PCT No.: PCT/JP2021/021600

§ 371 Date: May 24, 2023

(30) Foreign Application Priority Data
Jul. 15, 2020 (JP) 2020-121535

(51) Int. Cl. C09J 7/38; C09J 11/04; C09J 11/06; C09J 11/08; C09J 7/24; G02C 7/00

(52) U.S. Cl. CPC C09J 7/385; C09J 11/04; C09J 11/06; C09J 11/08; C09J 7/243; G02C 7/00; C09J 2301/302; C09J 2301/122

(57) ABSTRACT

One aspect of the present invention is a protection sheet for protecting a transparent sheet, the protection sheet including: a base material having a sheet shape; and a pressure-sensitive adhesive layer that peelably attaches the base material to the transparent sheet, wherein the pressure-sensitive adhesive layer contains an antistatic agent.

### TECHNICAL FIELD

The present invention relates to a protection sheet and a laminate body.

### BACKGROUND ART

A part of the face may be covered with a transparent sheet such as a face shield, a face guard, glasses, sunglasses, and goggles. Such a transparent sheet covering the face may be scratched, for example, due to contact with something. When the transparent sheet thus scratched is worn so as to cover a part of the face, particularly the periphery of the eye, there is a problem that the visibility of the wearer is deteriorated, such as a problem that the wearer hardly sees the periphery. Therefore, it is conceivable to protect the transparent sheet by attaching the protection sheet or the like to the transparent sheet before use or when not in use. In addition to the transparent sheet used to cover the face as described above, the transparent sheet may be scratched by contact with something before use at the time of transportation or the like. In addition, when a product (optical product or the like) utilizing the transparency is produced using a transparent sheet, it is also considered that the transparent sheet is scratched by, for example, contact with other members. In order to prevent scratching as described above, it is conceivable to protect the transparent sheet by attaching the protection sheet or the like to the transparent sheet. Examples of such a material protecting the transparent sheet include a goggle shield described in Patent Literature 1.

Patent Literature 1 describes a goggle shield that is attached to goggles by a plurality of snap fasteners and protects the eyes of a wearer, the goggle shield including: a shield main body made of a transparent plastic film; and a protection seal that covers a region of a surface of the shield main body in close contact with a region other than a region where the snap fastener is disposed and is provided to be peelable from the shield main body at the time of use.

Patent Literature 1 states that it is possible to prevent adhesion of dust or the like to a shield before use and to obtain a good field of view at the time of use.

However, according to studies by the present inventors, it has been found that even when a protection sheet is simply attached to a transparent sheet as in Patent Literature 1, if the protection sheet is peeled off at the time of use, dust or the like may adhere to the transparent sheet. In addition, when such a transparent sheet is used to cover the face, for example, the transparent sheet may be fogged by exhalation of the wearer. As described above, in a case where dust or the like adheres to the transparent sheet or the transparent sheet is fogged, for example, when the transparent sheet is worn so as to cover a part of the face, a problem occurs that the visibility of the wearer is lowered. Further, when the transparent sheet is used for the purpose of utilizing its transparency in a case other than the case where the transparent sheet is used to cover the face, the transparency of the transparent sheet cannot be sufficiently exhibited when dust or the like adheres to the transparent sheet or the transparent sheet is fogged. From these facts, the transparent sheet is required to be capable of suppressing adhesion of dust or the like even after the protection sheet for preventing scratching has been peeled off. Further, the transparent sheet is required to have high antifogging properties and to be less likely to be fogged even in a situation where the transparent sheet is likely to be fogged, for example, when exhalation of the wearer impinges on the transparent sheet.

### CITATION LIST

### Patent Literature

Patent Literature 1: JP 2016-131725 A

### SUMMARY OF INVENTION

The present invention has been made in view of such circumstances, and an object of the present invention is to provide a protection sheet capable of not only protecting a transparent sheet by being attached to the transparent sheet, but also capable of making the transparent sheet (the transparent sheet after the protection sheet is peeled off) into a transparent sheet which sufficiently suppresses adhesion of dust or the like and further has high antifogging properties after the protection sheet is peeled off from the transparent sheet. Another object of the present invention is to provide a laminate body in which a protection sheet is attached to a transparent sheet, and which can realize a transparent sheet which sufficiently suppresses adhesion of dust or the like and further has high antifogging properties after the protection sheet is peeled off.

One aspect of the present invention is a protection sheet for protecting a transparent sheet, the protection sheet including: a base material having a sheet shape; and a pressure-sensitive adhesive layer that peelably attaches the base material to the transparent sheet, wherein the pressure-sensitive adhesive layer contains an antistatic agent.

The above and other objects, features and advantages of the present invention will become apparent from the following detailed description.

### BRIEF DESCRIPTION OF DRAWINGS

FIG. 1 is a schematic cross-sectional view illustrating a face shield including a laminate body according to an embodiment of the present invention.

### DESCRIPTION OF EMBODIMENTS

According to the study of the present inventors, it has been found that dust or the like adheres to the transparent sheet after the protection sheet is peeled off because peeling electrification occurs in the transparent sheet due to peeling of the protection sheet. For this reason, it is conceivable to use a transparent sheet that is less likely to cause peeling electrification. The present inventors have focused on a pressure-sensitive adhesive layer for peelably attaching the protection sheet to the transparent sheet without changing the transparent sheet, and have studied in detail the composition and the like of the pressure-sensitive adhesive layer. As a result, the present inventors have found that the above object is achieved by the following present invention.

Hereinafter, embodiments according to the present invention will be described, but the present invention is not limited thereto.

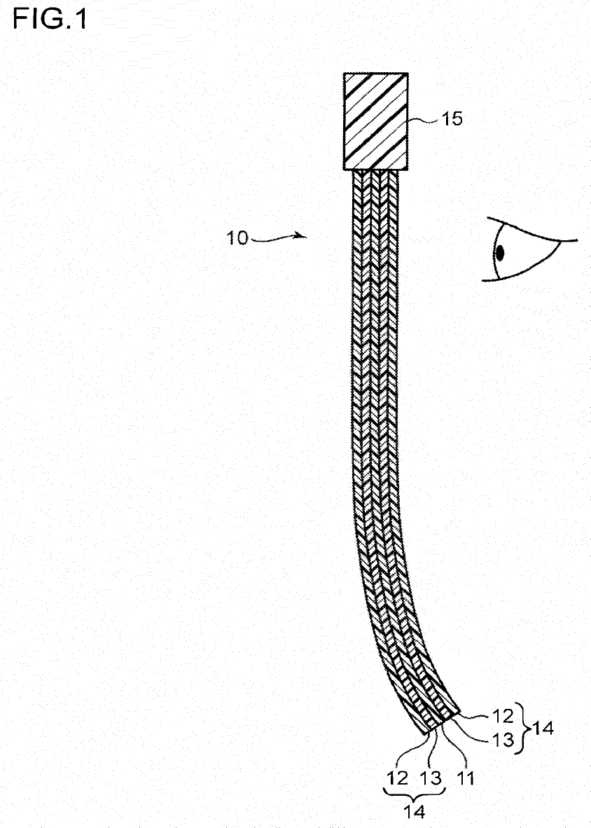

As illustrated in FIG. 1, a protection sheet 14 according to an embodiment of the present invention is a protection sheet that protects a transparent sheet 11 that covers at least a part of the face. The protection sheet 14 includes a base material 12 having a sheet shape, and a pressure-sensitive adhesive layer 13 that peelably attaches the base material 12 to the transparent sheet 11. The pressure-sensitive adhesive layer 13 contains an antistatic agent. As illustrated in FIG. 1, a laminate body 10 according to another embodiment of the present invention includes the protection sheet 14 and the transparent sheet 11, and the protection sheet 14 is laminated on the transparent sheet 11 such that the pressure-sensitive adhesive layer 13 is in contact with the transparent sheet 11. That is, the laminate body 10 includes the transparent sheet 11, the base material 12, and the pressure-sensitive adhesive layer 13 that peelably attaches the base material 12 to the transparent sheet 11. As described above, it is considered that when the pressure-sensitive adhesive layer 13 for peelably attaching the base material 12 to the transparent sheet 11 contains the antistatic agent, the antistatic agent remains on the surface of the transparent sheet 11 to which the protection sheet 14 had been attached after the protection sheet 14 is peeled off. Further, it is also considered that, when the pressure-sensitive adhesive layer 13 had been in contact with the transparent sheet 11, the antistatic agent contained in the pressure-sensitive adhesive layer 13 is transferred to the transparent sheet from the surface side of the transparent sheet 11 to which the protection sheet 14 had been attached. From these, it is considered that, after the protection sheet 14 is peeled off, the surface of the transparent sheet 11 to which the base material 12 had been attached can be prevented from being charged. Therefore, it is considered that the transparent sheet 11 can sufficiently suppress adhesion of dust or the like even after the protection sheet 14 is peeled off. In addition, it is considered that the antistatic agent, which has high hydrophilicity, adsorbs moisture in the air and exhibits conductivity and an antifogging effect on the surface side of the transparent sheet 11 to which the protection sheet 14 had been attached. As described above, the protection sheet 14 can protect the transparent sheet 11 by being attached to the transparent sheet 11. Further, when the protection sheet 14 is attached to the transparent sheet 11 and then the transparent sheet 11 is peeled off, it is possible to make the transparent sheet 11 into a transparent sheet which sufficiently suppresses adhesion of dust or the like and further has high antifogging properties. Further, the laminate body 10 can realize a transparent sheet which sufficiently suppresses adhesion of dust or the like to the transparent sheet 11 and further has high antifogging properties after the protection sheet 14 is peeled off. Also, before the transparent sheet 11 is used to cover at least a part of the face (before use), the protection sheet 14 is attached to the transparent sheet 11, so that the transparent sheet 11 can be prevented from being scratched. Even when the protection sheet 14 is peeled off in order to use the transparent sheet 11, it is possible to realize a transparent sheet which sufficiently suppresses adhesion of dust or the like and further has high antifogging properties as described above.

The application of the laminate body 10 is not particularly limited as long as the transparent sheet 11 is used to cover at least a part of the face, but for example, the transparent sheet 11 provided in the laminate body 10 is preferably used for a face shield, a face guard, glasses, sunglasses, or goggles. Examples of the glasses include, in addition to general glasses, glasses used in experiments and the like, so-called protection glasses. Note that FIG. 1 is a schematic cross-sectional view illustrating the laminate body 10 in the case of being used for a face shield as an example thereof. That is, FIG. 1 is a schematic cross-sectional view illustrating a face shield including the laminate body 10 according to the present embodiment. When the laminate body 10 is used as a face shield, as illustrated in FIG. 1, the laminate body 10 is held by a holding part 15 so that the laminate body 10 covers the face of the wearer, and used. When the face shield is used in practice, the protection sheet 14 is peeled off from the transparent sheet 11 before or after the laminate body 10 is held, and the face shield is used in a state where at least a part of the face is covered with the transparent sheet 11.

The transparent sheet is not particularly limited as long as it is a transparent sheet capable of covering at least a part of the face. In a case where the transparent sheet also covers the eyes, the transparent sheet is preferably a member having higher transparency from the viewpoint of enhancing visibility. In addition, the transparent sheet preferably has strength corresponding to the use of the laminate body. For example, when the transparent sheet is used for a face shield, the transparent sheet is required to have strength required for the face shield. Examples of a material constituting the transparent sheet include polyesters such as polyethylene terephthalate (PET) and polyethylene naphthalate (PEN), polyolefins such as polyethylene and polypropylene, styrene-based resins such as polystyrene and an acrylonitrile-butadiene-styrene copolymer (ABS), polyvinyl chloride, triacetyl cellulose (TAC), isosorbide polycarbonate, polycarbonate, a cycloolefin polymer, a cycloolefin copolymer, an acrylic resin, and a methacrylic resin. The transparent sheet may be formed by using these materials alone, or may be formed by using two or more of these materials in combination. The transparent sheet is often an insulator, and is, for example, an insulator when the transparent sheet is a member made of any of the exemplified materials. Since the transparent sheet is an insulator, peeling electrification is likely to occur after the protection sheet is peeled off, so that dust or the like is likely to adhere to the transparent sheet. Even when the transparent sheet is made of such a material, it is possible to realize a transparent sheet which sufficiently suppresses adhesion of dust or the like and further has high antifogging properties, as long as the laminate body has the above configuration. Among these materials, the transparent sheet preferably contains at least one selected from the group consisting of polyester, polycarbonate, and isosorbide polycarbonate. For example, even when a general transparent sheet such as a sheet (a PET sheet or the like) made of polyester such as PET is used as the transparent sheet, as described above, it is possible to realize a transparent sheet which sufficiently suppresses adhesion of dust or the like and further has high antifogging properties, as long as the laminate body has the above configuration. A transparent sheet containing polycarbonate, such as a sheet made of polycarbonate, exhibits an effect of enhancing transparency and impact resistance. In addition, a transparent sheet containing isosorbide polycarbonate, such as a sheet made of isosorbide polycarbonate, exhibits an effect (bacteria repellency) of preventing adhesion of bacteria or the like. The laminate body having the above configuration can provide a transparent sheet which sufficiently suppresses adhesion of dust or the like and further has high antifogging properties, and further exhibit an effect that the transparent sheet itself has. That is, inclusion of the isosorbide polycarbonate in the transparent sheet yields an effect of realizing a transparent sheet which sufficiently suppresses adhesion of dust or the like and further has high antifogging properties, and further yields an effect of preventing adhesion of bacteria or the like.

The thickness of the transparent sheet varies depending on the material constituting the transparent sheet, and the like, and is, for example, preferably 100 to 300 μm, and more preferably 150 to 250 μm. When the transparent sheet is too thin, the strength thereof tends to decrease. In addition, when the transparent sheet is too thick, there is a tendency that the visibility of the wearer is lowered or usability is deteriorated. Therefore, when the transparent sheet has the thickness as described above, the transparent sheet can sufficiently exhibit the strength according to the application of the laminate body, for example, the strength required as a face shield while ensuring the visibility of the wearer.

The base material is not particularly limited as long as it is a sheet that can be attached to the transparent sheet with the pressure-sensitive adhesive layer. Examples of a material constituting the base material include polyesters such as polyethylene terephthalate (PET) and polyethylene naphthalate (PEN), polyolefins such as polyethylene and polypropylene, polystyrene, polycarbonate, and polyamide. The base material may be formed by using these materials alone or may be formed by using two or more of these materials in combination. Examples of the base material include a biaxially stretched polypropylene film and an unstretched polypropylene film. The base material may be a sheet containing at least one selected from the group consisting of polyester and polypropylene among these materials. Even when a base material containing polyester or polypropylene is used as the base material, that is, even when the base material is a base material that does not particularly have the effects of preventing adhesion of dust to the transparent sheet and enhancing antifogging properties, it is possible to realize a protection sheet capable of providing a transparent sheet which sufficiently suppresses adhesion of dust or the like and further has high antifogging properties, as long as the protection sheet satisfies the above configuration, that is, the protection sheet is a protection sheet containing an antistatic agent in the pressure-sensitive adhesive layer, which is preferable.

The thickness of the base material varies depending on the material constituting the base material, and the like, and is, for example, preferably 10 to 100 μm and more preferably 30 to 80 μm. When the base material is a PET sheet, the thickness of the base material is preferably 38 to 75 μm. When the base material is a biaxially stretched polypropylene film, the thickness of the base material is preferably 30 to 70 μm. When the base material is too thin, the transparent sheet cannot be sufficiently protected, or the protection sheet tends to be damaged when peeled off. In addition, when the base material is too thick, the rigidity thereof becomes too high, and there is a tendency that the base material becomes difficult to be attached according to the shape of the transparent sheet when the transparent sheet is bent and used. Therefore, the base material having the above thickness can appropriately protect the transparent sheet, and allows the protection sheet to be appropriately peeled off. Further, the base material having the above thickness can be appropriately attached according to the shape of the transparent sheet, that is, even when the transparent sheet is bent and used, the base material can be appropriately attached according to the bending.

The pressure-sensitive adhesive layer is not particularly limited as long as it is a pressure-sensitive adhesive layer that peelably attaches the base material to the transparent sheet and contains an antistatic agent. Examples of the pressure-sensitive adhesive layer include not only a layer containing an antistatic agent, but also a layer containing a general pressure-sensitive adhesive.

The antistatic agent is not particularly limited, and examples thereof include ion conductive antistatic agents and surfactant antistatic agents.

The ion conductive antistatic agent is not particularly limited, and examples thereof include a lithium ion type antistatic agent in which a lithium salt is dissolved in a silicone resin which is liquid at 25° C.; and a lithium ion type antistatic agent in which a lithium salt is dissolved in a polymer containing a polyalkylene glycol as a main component. Examples of the silicone resin include silicone oil and modified silicone oil. Examples of the lithium salt include lithium perchlorate. Specific examples of the ion conductive antistatic agent include an ion conductivity imparting agent obtained by complexing lithium perchlorate or the like with a polymer containing a polyalkylene glycol as a main component; and an ion conductive antistatic agent in which a Li salt is dissolved in modified silicone oil.

Examples of the surfactant antistatic agent include a nonionic surfactant, an anionic surfactant, a cationic surfactant, and an amphoteric surfactant. Examples of the nonionic surfactant include ether type surfactants such as polyoxyethylene alkyl ethers, polyoxyalkylene alkyl ethers, and polyoxyethylene alkyl phenyl ethers; ester type surfactants such as glycerin fatty acid esters and polyoxyethylene alkylamine fatty acid esters; and fatty acid alkanolamide type surfactants such as XX-bis(2-hydroxyethyl)alkylamines, alkyldiethanolamines, y-2-hydroxyethyl-y-2-hydroxyalkylamines, hydroxyalkylmonoethanolamines, polyoxyethylene alkylamines, and alkyldiethanolamides. Examples of the anionic surfactant include an alkylbenzene sulfonate, an alkylsulfonate, an alkyl phosphate, and a polyoxyalkylene alkyl ether sulfate. Examples of the polyoxyalkylene alkyl ether sulfate include an anionic surfactant obtained by sulfating a terminal hydroxyl (OH) group of a polyoxyalkylene alkyl ether and neutralizing the sulfated terminal hydroxyl (OH) group with an alkali. Examples of the cationic surfactant include trialkylbenzylammonium salts and tetraalkylammonium salts. Examples of the amphoteric surfactant include alkylimidazolium betaine and alkyl betaine.

The antistatic agents may be used alone or in combination of two or more types thereof. Among the above antistatic agents, the antistatic agent is preferably a lithium ion type antistatic agent in which a lithium salt is dissolved in a silicone resin which is liquid at 25° C. and a polyoxyalkylene alkyl ether sulfate, and more preferably a lithium ion type antistatic agent in which a lithium salt is dissolved in a silicone resin which is liquid at 25° C.

The pressure-sensitive adhesive is not particularly limited as long as it can form a pressure-sensitive adhesive layer that peelably attaches the base material to the transparent sheet. Examples of the pressure-sensitive adhesive include acrylic pressure-sensitive adhesives, urethane-based pressure-sensitive adhesives, acrylic urethane-based pressure-sensitive adhesives, and silicone-based pressure-sensitive adhesives. Examples of the acrylic pressure-sensitive adhesive include a 2-ethylhexyl acrylate resin. As the pressure-sensitive adhesive, an acrylic pressure-sensitive adhesive is preferably used from the viewpoint of adhesive force and cost. The pressure-sensitive adhesive layer preferably contains the pressure-sensitive adhesive layer, and further contains a curing agent. The curing agent is not particularly limited as long as it is a curing agent capable of curing the pressure-sensitive adhesive while maintaining the tackiness of the pressure-sensitive adhesive, and examples thereof include an isocyanate-based curing agent. That is, the pressure-sensitive adhesive layer preferably contains an acrylic pressure-sensitive adhesive as a pressure-sensitive adhesive, and further contains an isocyanate-based curing agent.

The content of the antistatic agent is preferably 0.5 to 8 parts by mass, and more preferably 2 to 4 parts by mass, per 100 parts by mass of the pressure-sensitive adhesive. When the content of the antistatic agent is too small, there is a tendency that the effect exerted by containing the antistatic agent in the pressure-sensitive adhesive layer cannot be sufficiently achieved. In addition, when the content of the antistatic agent is too large, the effect exerted by containing the antistatic agent in the pressure-sensitive adhesive layer is saturated, and the content of the pressure-sensitive adhesive is relatively reduced, so that the tackiness of the pressure-sensitive adhesive layer tends to decrease. Therefore, when the content of the antistatic agent is within the above range, the base material can be suitably peelably attached to the transparent sheet, and the effect exerted by containing the antistatic agent in the pressure-sensitive adhesive layer can be sufficiently achieved.

The content of the curing agent is preferably 0.5 to 5 parts by mass, and more preferably 1 to 3 parts by mass, per 100 parts by mass of the pressure-sensitive adhesive. When the content of the curing agent is too small, that is, when the content of the pressure-sensitive adhesive is too large, the pressure-sensitive adhesive cannot be suitably cured, and there is a tendency that the function as the pressure-sensitive adhesive layer, that is, the function of peelably attaching the base material to the transparent sheet cannot be sufficiently exhibited. When the content of the curing agent is too large, that is, when the content of the pressure-sensitive adhesive is too small, the tackiness of the obtained pressure-sensitive adhesive layer decreases, and there is a tendency that the function as the pressure-sensitive adhesive layer, that is, the function of peelably attaching the base material to the transparent sheet cannot be sufficiently exhibited.

The method for producing the protection sheet is not particularly limited as long as the protection sheet can be produced. As a method for producing the protection sheet, for example, first, a liquid composition (composition for forming a pressure-sensitive adhesive layer) in which the antistatic agent, as necessary, the pressure-sensitive adhesive, and the curing agent are dissolved or dispersed in a solvent (diluent solvent) is prepared. The prepared composition for forming a pressure-sensitive adhesive layer is applied onto the base material to form the pressure-sensitive adhesive layer. In this way, the protection sheet may be produced. The method for producing the laminate body is not particularly limited as long as the laminate body can be produced. As a method for producing the laminate body, for example, the protection sheet and the transparent sheet are laminated such that a surface of the protection sheet on which the pressure-sensitive adhesive layer is formed is in contact with the transparent sheet. In this way, the laminate body may be produced.

The diluent solvent is not particularly limited as long as it is a solvent capable of suitably dissolving or dispersing the antistatic agent, the pressure-sensitive adhesive, the curing agent, and the like, and examples of the diluent solvent include toluene and ethyl acetate. Either toluene or ethyl acetate may be used for the diluent solvent, or a mixed solvent obtained by mixing two types may be used. Among them, the diluent solvent is preferably a mixed solvent of toluene and ethyl acetate.

The thickness of the pressure-sensitive adhesive layer varies depending on the material constituting the pressure-sensitive adhesive layer, and the like, and is, for example, preferably 2 to 30 μm and more preferably 5 to 15 μm. That is, the coating amount of the composition for forming a pressure-sensitive adhesive layer is preferably such a coating amount that the thickness of the pressure-sensitive adhesive layer to be obtained falls within the above range. When the pressure-sensitive adhesive layer is too thin, there is a tendency that the pressure-sensitive adhesive layer have insufficient tackiness, and the effect exerted by containing the antistatic agent in the pressure-sensitive adhesive layer cannot be sufficiently achieved. When the pressure-sensitive adhesive layer is too thick, a part of the pressure-sensitive adhesive layer tends to remain on the transparent sheet when the protection sheet is peeled off from the transparent sheet. Therefore, the pressure-sensitive adhesive layer having the above thickness, can sufficiently exhibit the function as the pressure-sensitive adhesive layer, that is, the function of peelably attaching the base material to the transparent sheet, and sufficiently exhibit the effect exerted by containing the antistatic agent in the pressure-sensitive adhesive layer.

In the laminate body, the protection sheet may be each provided on both surface sides of the transparent sheet, or may be provided on one of the surface sides of the transparent sheet. At that time, the protection sheet is preferably provided at least on a surface of the transparent sheet on a side close to the face. Disposing the protection sheet in such a way allows the transparent sheet to exhibit antifogging properties on its surface on a side close to the face where antifogging properties are more required. That is, when the transparent sheet is used to cover at least a part of the face, antifogging properties can be exhibited on a surface of the transparent sheet on a side close to the face, which is easily fogged by exhalation of the user (wearer). Further, it is possible to suppress adhesion of dust or the like to the surface of the transparent sheet on a side close to the face. When the transparent sheet is used to cover at least a part of the face, it is difficult to wipe the surface of the transparent sheet on a side close to the face, so that it is possible to suppress adhesion of dust or the like to the surface of the transparent sheet on a side close to the face, which is the surface on the side difficult to wipe.

Incidentally, the protection sheet is preferably provided at least on the surface of the transparent sheet on a side close to the face. Therefore, when the protection sheet is further provided on the surface of the transparent sheet on the side far from the face, that is, the protection sheet is provided on both surfaces of the transparent sheet, it is also possible to sufficiently suppress adhesion of dust or the like to the surface of the transparent sheet on the side far from the face, and enhance antifogging properties.

The laminate body is preferably used for an application in which the transparent sheet is used to cover at least a part of the face. The application thereof is specifically face shields, face guards, glasses, sunglasses, and goggles. That is, the transparent sheet provided in the laminate body is preferably used for a face shield, a face guard, glasses, sunglasses, or goggles. When the transparent sheet is used for such applications, it is possible to provide a face shield, a face guard, glasses, sunglasses, or goggles which can suppress scratching with the protection sheet before use, and sufficiently suppresses adhesion of dust or the like and further has high antifogging properties even when the protection sheet is peeled off at the time of use, as described above.

As the transparent sheet protected by the protection sheet and the transparent sheet provided in the laminate body, a transparent sheet that covers at least a part of the face has been described above, but the present invention is not limited thereto. The transparent sheet is not particularly limited as long as it is a sheet having transparency, and is not limited to a transparent sheet requiring visibility with the naked eye, such as a transparent sheet that covers at least a part of the face. The transparent sheet may also be a transparent sheet used for an optical component or the like.

Examples of the transparent sheet requiring visibility with the naked eye include transparent sheets used in a wide range of fields such as building materials, cars and traffic, and household goods, in addition to the above transparent sheet that covers at least a part of the face, used for face shields, face guards, glasses, sunglasses, goggles, and the like. Examples of the transparent sheet used in the field of building material include a transparent sheet (more specifically, a glass plate of a front surface of a refrigerator of a convenience store, an acrylic plate of a water tank in an aquarium, and the like) in a display medium having a temperature difference from an external environment, a transparent sheet of a container or the like (a transparent sheet or the like constituting a transparent portion of the container) for the purpose of appreciating an object to be displayed in a museum, an art museum, an aquarium, and the like, a transparent sheet constituting a display surface of an advertisement member using information display, a transparent sheet constituting a mirror of a bathroom wash basin, and a window glass. For example, when the transparent sheet is used for a window glass, it is possible to realize a window glass which prevents adhesion of dust and is not fogged even on a rainy day even after the protection sheet is peeled off, by attaching the protection sheet according to the present embodiment to the window glass. Examples of the transparent sheet used in the field of cars and traffic include transparent sheets constituting a windshield of a car and a curve mirror on a road. Examples of the transparent sheet used in the field of household goods include a transparent sheet used for a window of a camping tent, a transparent sheet in a packaging bag for vegetables, fruits, and the like (for example, a transparent sheet used in a state in which water droplets derived from vegetables or the like stored in a packaging bag adhere to the transparent sheet), a transparent sheet constituting a transparent portion in an insect cage, a transparent sheet constituting a transparent portion in an umbrella having a transparent portion in at least a part thereof (for example, a plastic umbrella or the like), and a transparent sheet constituting a transparent portion in a mask having a transparent portion in at least a part thereof (for example, a mask or the like that can maintain transparency to the extent that face authentication can be performed). For example, when the transparent sheet is used for a transparent sheet constituting a transparent portion in an umbrella having a transparent portion in at least a part thereof, an umbrella can be obtained in which the transparent portion is less likely to be fogged and the front is easily viewed. That is, attaching the protection sheet according to the present embodiment to the transparent sheet allows the transparent sheet to exhibit antifogging properties even after the protection sheet is peeled off, and thus realizes an umbrella in which the front is easily viewed. In addition, for example, when the transparent sheet is used for a transparent sheet constituting a transparent portion in a mask having a transparent portion in at least a part thereof, it is possible to provide a mask whose transparent portion is less likely to be fogged, for example, a mask or the like capable of maintaining transparency to the extent that face authentication can be performed. That is, attaching the protection sheet according to the present embodiment to the transparent sheet allows the transparent sheet to exhibit antifogging properties even after the protection sheet is peeled off, and thus realizes a mask that maintains transparency. In addition, among the transparent sheets exemplified as the transparent sheet that covers at least a part of the face, those that are less affected by exhalation of the wearing car may be used. Examples thereof include swimming goggles and box glasses (for example, a box or the like used by a female diver to see the inside of the sea).

Examples of the transparent sheet used as the optical component include a transparent sheet used in the field of displays, a transparent sheet constituting a lens, a transparent sheet constituting a surface portion of an optical shutter, and a transparent sheet constituting a surface portion of a solar panel. Examples of the transparent sheet used in the field of displays include a transparent sheet constituting a projection surface of a head-up display (regardless of means of transportation such as vehicles, aircrafts, and ships, fields of projecting and using information, games, finance, and the like), and a transparent sheet constituting a window for 3D mapping (for example, windows or the like installed in the Sky Tree). Examples of the lens include a lens of a camera and a lens of a drive recorder. Examples of the transparent sheet constituting a surface portion of the optical shutter include a transparent sheet constituting a surface portion of the optical shutter using liquid crystal, charged particles, charged liquid, and the like. In the solar panel, when the transparency of the transparent sheet constituting a surface portion is lowered (fogged), light is diffused and the power generation efficiency of the solar panel is lowered. Therefore, the transparent sheet is required to have antifogging properties and the like. On the other hand, attaching the protection sheet according to the present embodiment to the transparent sheet constituting a surface portion of the solar panel prevents dust from adhering to the transparent sheet and also allows the transparent sheet to exhibit antifogging properties even after the protection sheet is peeled off, and thus can provide a solar panel that maintains power generation efficiency.

The protection sheet is not limited to a transparent sheet that covers at least a part of the face, and any transparent sheet can be protected by attaching the protection sheet to the transparent sheet. Further, after the protection sheet is peeled off from the transparent sheet, it is possible to obtain a transparent sheet which sufficiently suppresses adhesion of dust or the like and further has high antifogging properties.

As described above, the present specification discloses various aspects of the technology, and the main technologies are summarized below.

One aspect of the present invention is a protection sheet for protecting a transparent sheet, the protection sheet including: a base material having a sheet shape; and a pressure-sensitive adhesive layer that peelably attaches the base material to the transparent sheet, wherein the pressure-sensitive adhesive layer contains an antistatic agent.

With such a configuration, it is possible to provide a protection sheet capable of not only protecting the transparent sheet by being attached to the transparent sheet, but also capable of making the transparent sheet (the transparent sheet after the protection sheet is peeled off) into a transparent sheet which sufficiently suppresses adhesion of dust or the like and further has high antifogging properties after the protection sheet is peeled off from the transparent sheet. That is, it is possible to prevent the transparent sheet from being scratched by attaching the protection sheet to the transparent sheet before use of the transparent sheet, for example, at the time of transportation. Then, when the transparent sheet is used, the protection sheet is peeled off, and a transparent sheet can be realized which sufficiently suppresses adhesion of dust or the like and further has high antifogging properties, as described above.

This is considered to be due to the following.

It is considered that inclusion of the antistatic agent in the pressure-sensitive adhesive layer for peelably attaching the protection sheet to the transparent sheet allows the antistatic agent to remain on a surface of the transparent sheet to which the protection sheet had been attached after the protection sheet is peeled off. Further, it is also considered that, due to contact of the pressure-sensitive adhesive layer with the transparent sheet, the antistatic agent contained in the pressure-sensitive adhesive layer is transferred to the transparent sheet from the surface side of the transparent sheet to which the protection sheet had been attached. From these facts, it is considered that even when the pressure-sensitive adhesive layer containing the antistatic agent is peeled off when the protection sheet is peeled off, the surface of the transparent sheet to which the protection sheet had been attached can be prevented from being charged. Therefore, it is considered that adhesion of dust or the like to the transparent sheet can be sufficiently suppressed after the protection sheet is peeled off. The antistatic agent has high hydrophilicity. From this fact, it is considered that the antistatic agent remaining on the surface of the transparent sheet to which the protection sheet had been attached, and the antistatic agent transferred from the pressure-sensitive adhesive layer to the transparent sheet adsorb moisture in the air to exhibit conductivity and thus exhibit an antifogging effect.

As described above, the protection sheet can protect the transparent sheet by being attached to the transparent sheet. Further, it is considered that the transparent sheet (the transparent sheet after the protection sheet is peeled off) can be made into a transparent sheet which sufficiently suppresses adhesion of dust or the like and further has high antifogging properties by attaching the protection sheet to the transparent sheet and then peeling off the protection sheet. Further, even when the transparent sheet itself does not particularly have the effects of preventing adhesion of dust and enhancing antifogging properties, it is possible to realize a transparent sheet which sufficiently suppresses adhesion of dust or the like and further has high antifogging properties only by attaching the protection sheet to the transparent sheet and then peeling off the protection sheet.

In the protection sheet, the antistatic agent is preferably at least one selected from the group consisting of an ion conductive antistatic agent and a surfactant antistatic agent.

With such a configuration, it is possible to provide a protection sheet capable of making the transparent sheet into a transparent sheet which further suppresses adhesion of dust or the like and further has antifogging properties after the protection sheet is peeled off from the transparent sheet.

In the protection sheet, the antistatic agent is preferably a lithium ion type antistatic agent in which a lithium salt is dissolved in a silicone resin which is liquid at 25° C.

With such a configuration, it is possible to provide a protection sheet capable of making the transparent sheet into a transparent sheet which further suppresses adhesion of dust or the like and further has antifogging properties after the protection sheet is peeled off from the transparent sheet.

In the protection sheet, the pressure-sensitive adhesive layer preferably further contains an acrylic pressure-sensitive adhesive and an isocyanate-based curing agent.

With such a configuration, it is possible to provide a protection sheet capable of making the transparent sheet into a transparent sheet which further suppresses adhesion of dust or the like and further has antifogging properties after the protection sheet is peeled off from the transparent sheet. In addition, even when the pressure-sensitive adhesive layer is a general pressure-sensitive adhesive layer, such as a pressure-sensitive adhesive layer containing an acrylic pressure-sensitive adhesive and an isocyanate-based curing agent, if the pressure-sensitive adhesive layer contains an antistatic agent as described above, the effect of suppressing adhesion of dust or the like and further enhancing antifogging properties can be imparted to the transparent sheet.

In the protection sheet, the base material may contain at least one selected from the group consisting of polyester and polypropylene.

With such a configuration, even when a base material containing polyester or polypropylene is used as the base material, that is, even when the base material is a base material that does not particularly have the effects of preventing adhesion of dust to the transparent sheet and enhancing antifogging properties, it is possible to realize a protection sheet capable of making a transparent sheet which sufficiently suppresses adhesion of dust or the like and further has high antifogging properties, as long as the protection sheet satisfies the above configuration, that is, the protection sheet contains an antistatic agent in the pressure-sensitive adhesive layer, which is preferable.

In the protection sheet, the transparent sheet is preferably a transparent sheet that covers at least a part of the face. That is, the protection sheet is preferably applied to a transparent sheet that covers at least a part of the face.

When the transparent sheet is used to cover at least a part of the face, the transparent sheet may be fogged by exhalation of a wearer wearing the transparent sheet. Even in the case where the transparent sheet is used as described above, when the protection sheet is peeled off and the transparent sheet is used, it is possible to realize a transparent sheet which sufficiently suppresses adhesion of dust or the like and further has high antifogging properties. For this reason, the protection sheet is preferably applied to a transparent sheet that covers at least a part of the face.

Another aspect of the present invention is a laminate body including: the protection sheet; and the transparent sheet, wherein the protection sheet is laminated on the transparent sheet such that the pressure-sensitive adhesive layer provided in the protection sheet is in contact with the transparent sheet.

With such a configuration, it is possible to provide a laminate body in which a protection sheet is attached to a transparent sheet, and which can realize a transparent sheet which sufficiently suppresses adhesion of dust or the like and further has high antifogging properties after the protection sheet is peeled off. It is possible to prevent the transparent sheet from being scratched by attaching the protection sheet to the transparent sheet before use of the transparent sheet, for example, at the time of transportation. Then, when the transparent sheet is used, the protection sheet is peeled off, and a transparent sheet can be realized which sufficiently suppresses adhesion of dust or the like and further has high antifogging properties, as described above.

In the laminate body, the transparent sheet preferably contains at least one selected from the group consisting of polyester, polycarbonate, and isosorbide polycarbonate.

A laminate body with such a configuration can exhibit an effect realizing a transparent sheet which sufficiently suppresses adhesion of dust or the like and further has high antifogging properties, and further exhibit an effect that the transparent sheet itself has. For example, when the transparent sheet contains polycarbonate, the transparent sheet also exhibits an effect of enhancing transparency and impact resistance. In addition, when the transparent sheet contains isosorbide polycarbonate, the transparent sheet exhibits an effect of preventing adhesion of bacteria or the like to the transparent sheet. In addition, even though the transparent sheet containing at least one selected from the group consisting of polyester, polycarbonate, and isosorbide polycarbonate is not made of a material that prevents adhesion of dust or a material that enhances antifogging properties, it is possible to realize a transparent sheet which sufficiently suppresses adhesion of dust or the like and further has high antifogging properties, as long as the laminate body satisfies the above configuration, that is, the laminate body contains an antistatic agent in the pressure-sensitive adhesive layer.

In the laminate body, the transparent sheet is preferably a transparent sheet that covers at least a part of the face.

When the transparent sheet is used to cover at least a part of the face, as described above, the transparent sheet may be fogged by exhalation of the wearer wearing the transparent sheet. Even when the transparent sheet is used in this manner, the laminate body can realize a transparent sheet which sufficiently suppresses adhesion of dust or the like and further has high antifogging properties after the protection sheet is peeled off.

In the laminate body, the protection sheet is preferably provided at least on a surface of the transparent sheet on a side close to the face.

With such a configuration, antifogging properties can be exhibited on the surface of the transparent sheet on a side close to the face where antifogging properties are more required. That is, when the transparent sheet is used to cover at least a part of the face, antifogging properties can be exhibited on a surface of the transparent sheet on a side close to the face, which is easily fogged by exhalation of the user (wearer). Further, it is possible to suppress adhesion of dust or the like to the surface of the transparent sheet on a side close to the face. When the transparent sheet is used to cover at least a part of the face, it is difficult to wipe the surface of the transparent sheet on a side close to the face, so that it is possible to suppress adhesion of dust or the like to the surface of the transparent sheet on a side close to the face, which is the surface on the side difficult to wipe. Incidentally, the protection sheet is preferably provided at least on the surface of the transparent sheet on a side close to the face. Therefore, when the protection sheet is further provided on the surface of the transparent sheet on the side far from the face, it is also possible to sufficiently suppress adhesion of dust or the like to the surface of the transparent sheet on the side far from the face, and enhance antifogging properties.

The transparent sheet provided in the laminate body is preferably used for a face shield, a face guard, glasses, sunglasses, or goggles.

With such a configuration, it is possible to provide a face shield, a face guard, glasses, sunglasses, or goggles which can suppress scratching with the protection sheet before use, and sufficiently suppresses adhesion of dust or the like and further has high antifogging properties even when the protection sheet is peeled off at the time of use, as described above.

According to the present invention, it is possible to provide a protection sheet capable of not only protecting the transparent sheet by being attached to the transparent sheet, but also capable of making the transparent sheet into a transparent sheet which sufficiently suppresses adhesion of dust or the like and further has high antifogging properties after the protection sheet is peeled off from the transparent sheet. According to the present invention, it is also possible to provide a laminate body in which a protection sheet is attached to a transparent sheet, and which can realize a transparent sheet which sufficiently suppresses adhesion of dust or the like and further has high antifogging properties after the protection sheet is peeled off.

Hereinafter, the present invention will be described more specifically with reference to Examples, but the scope of the present invention is not limited thereto.

### EXAMPLES

### Examples 1 to 6 and Comparative Example

In the present example, each component used in preparing a resin composition will be described.

[Transparent Sheet]

PET film (DIAFOIL T-100, manufactured by Mitsubishi Chemical Corporation, thickness: 188 μm)

[Protection Sheet]

(Substrate)

PET film (MR, manufactured by Mitsubishi Chemical Corporation, thickness: 50 μm)

(Composition for Forming Pressure-sensitive Adhesive Layer)

Acrylic pressure-sensitive adhesive: 2-Ethylhexyl acrylate resin (COPONYL N4399, manufactured by Mitsubishi Chemical Corporation)

Curing agent: Isocyanate-based curing agent (CORONAIE HX, manufactured by Tosoh Corporation)

Diluent solvent: Mixed solvent of toluene and ethyl acetate (mass ratio 1:1)

Antistatic agent 1: Polyoxyalkylene alkyl ether sulfate (EMAL 20C, manufactured by Kao Corporation, polyoxyalkylene alkyl ether sulfate is, for example, an anionic surfactant obtained by sulfating a terminal hydroxyl (OH) group of a polyoxyalkylene alkyl ether and neutralizing the sulfated terminal hydroxyl (OH) group with an alkali)

Antistatic agent 2: Ion conductive antistatic agent (PC6855C, manufactured by Marubishi Oil Chemical Corporation, lithium ion type antistatic agent in which a lithium salt is dissolved in a silicone resin which is liquid at 25° C.)

[Production Method]

First, the antistatic agent, the pressure-sensitive adhesive, and the curing agent were added to the diluent solvent in the composition (parts by mass) shown in Table 1, and mixed. The mixture was stirred for 20 minutes. Thus, a liquid composition was obtained in which the antistatic agent, the pressure-sensitive adhesive, and the curing agent were dissolved or dispersed in the diluent solvent. This composition was used as a composition for forming a pressure-sensitive adhesive layer.

Next, the prepared composition for forming a pressure-sensitive adhesive layer was applied onto one surface of the base material in such a coating amount that the finally obtained pressure-sensitive adhesive layer had a thickness of 10 μm, and then dried at 100° C. for 1 minute. A pressure-sensitive adhesive layer was thus formed on one surface of the base material. The protection sheet was thus obtained.

Then, the protection sheet and the transparent sheet were laminated such that a surface of the protection sheet on which the pressure-sensitive adhesive layer has been formed was in contact with the transparent sheet. The laminate body was thus obtained.

The protection sheet and the laminate body obtained as described above were evaluated by the following methods.

[Surface Resistivity]

The surface resistivity of the surface (pressure-sensitive adhesive layer surface) of the pressure-sensitive adhesive layer provided in the protection sheet was measured by the guarded-electrode system in accordance with JIS K 6911. Specifically, the protection sheet was placed in a constant-temperature and constant-humidity chamber adjusted to a temperature of 23° C. and a relative humidity of 50%, and the surface resistivity of the pressure-sensitive adhesive layer surface of the protection sheet of the above state was measured with an applied voltage of 500 V and an application time of 20 seconds set as the measurement conditions of the above guarded-electrode system.

The surface resistivity of the transparent sheet in each state was also measured in the same manner as described above except that a transparent sheet immediately after the protection sheet was peeled off from the laminate body (immediately after peeling), a transparent sheet 1 hour after peeling (after 1 hour from peeling), and a transparent sheet 24 hours after peeling (after 24 hours from peeling) were used in place of the protection sheet.

[Antifogging Effect]

Using a stainless steel water bath with a pipe heater, each of the transparent sheet after 1 hour from peeling and the transparent sheet after 24 hours from peeling was disposed at a position (height) at which the transparent sheet is exposed to steam generated from hot water held at 90° C. or higher, and a fogging state of each transparent sheet was visually observed.

As a result of the observation, a case where the time during which fogging could not be confirmed after the transparent sheet has been moved to the position where the transparent sheet is not exposed to the steam was 1 second or less was evaluated as “⊙”. A case where the time was more than 1 second and 5 seconds or less was evaluated as “◯”. A case where the time was more than 5 seconds and 9 seconds or less was evaluated as “Δ”. A case where the time was more than 9 seconds was evaluated as “x”.

These results are shown in Table 1 together with the composition of the composition for forming a pressure-sensitive adhesive layer. When the surface resistivity is too high to be measured by the above measurement method, it is denoted as “-”.

TABLE 1

| | | | | Example | Example | Example | Example | Example | Example | Comparative |
|---|---|---|---|---|---|---|---|---|---|---|
| | | | | 1 | 2 | 3 | 4 | 5 | 6 | Example |
| Composition | Composition | Acrylic pressure- | | 50 | 50 | 50 | 50 | 50 | 50 | 50 |
| (parts by | for forming | sensitive adhesive | | | | | | | | |
| mass) | pressure- | Curing agent | | 1 | 1 | 1 | 1 | 1 | 1 | 1 |
| | sensitive | Diluent solvent | | 70 | 70 | 70 | 70 | 70 | 70 | 70 |
| | adhesive | Antistatic agent 1 | | 0.5 | 1.5 | 3.0 | — | — | — | — |
| | layer | Antistatic agent 2 | | — | — | — | 0.5 | 1.5 | 3.0 | — |
| Evaluation | Surface | Pressure-sensitive | | 10¹⁰ | 10¹⁰ | 10¹⁰ | 10¹⁰ | 10¹⁰ | 10¹⁰ | — |
| | resistivity | adhesive layer surface | | | | | | | | |
| | (Ω/□) | Transparent | Immediately | 10¹² | 10¹² | 10¹¹ | 10¹² | 10¹¹ | 10¹⁰ | — |
| | | sheet surface | after peeling | | | | | | | |
| | | | After 1 hour | 10¹³ | 10¹² | 10¹¹ | 10¹² | 10¹¹ | 10¹¹ | — |
| | | | from peeling | | | | | | | |
| | | | After 24 hours | 10¹⁵ | 10¹³ | 10¹¹ | 10¹³ | 10¹¹ | 10¹¹ | — |
| | | | from peeling | | | | | | | |
| | Antifogging | Transparent | After 1 hour | ◯ | ◯ | ⊙ | ⊙ | ⊙ | ⊙ | × |
| | effect | sheet surface | from peeling | | | | | | | |
| | | | After 24 hours | Δ | ◯ | ⊙ | ⊙ | ⊙ | ⊙ | × |
| | | | from peeling | | | | | | | |

As can be seen from Table 1, the surface resistivity of the transparent sheet was lower in the case of using the pressure-sensitive adhesive layer containing an antistatic agent (Examples 1 to 6) than in the case of using the pressure-sensitive adhesive layer containing no antistatic agent (Comparative Example). Further, when a pressure-sensitive adhesive layer containing an antistatic agent was used (Examples 1 to 6), the surface resistivity of the transparent sheet could be maintained low after the protection film was peeled off. In particular, this tendency was strong in the case where a lithium ion type antistatic agent in which a lithium salt was dissolved in a silicone resin which was liquid at 25° C. was used as the antistatic agent (Examples 4 to 6), or the case where the content of the antistatic agent was high (for example, Example 3 and 6). This result shows that it is preferable to use, as the antistatic agent, a lithium ion type antistatic agent in which a lithium salt is dissolved in a silicone resin which is liquid at 25° C. The result also shows that the content of the antistatic agent is also preferably high within a range that does not cause defects due to a high content of the antistatic agent. This also indicates that the content of the antistatic agent is preferably within the above range, for example, 0.5 to 8 parts by mass per 100 parts by mass of the pressure-sensitive adhesive.

### Example 7

The same procedure was carried out as in Example 6 except that an isosorbide polycarbonate film (isosorbide polycarbonate film, manufactured by KEIWA Inc., thickness: 200 μm) was used as the transparent sheet in place of the PET film (DIAFOIL T-100, manufactured by Mitsubishi Chemical Corporation, thickness: 188 μm).

The evaluation results (surface resistivity and antifogging effect) of the obtained protection sheet and laminate body were the same as those in Example 6. Further, when an isosorbide polycarbonate film was used as the transparent sheet, an effect of preventing adhesion of bacteria or the like was also achieved. These results show that even when the transparent sheet is an isosorbide polycarbonate film, the effect of the invention of the present application is achieved. Further, the effect of the invention of the present application can be achieved regardless of the material of the transparent sheet. Further, the results show that when the isosorbide polycarbonate film is used as the transparent sheet, an effect of preventing adhesion of bacteria or the like, which is the effect that the isosorbide polycarbonate film originally has, is also achieved.

### Example 8

The same procedure was carried out as in Example 6 except that a polycarbonate film (polycarbonate film, manufactured by KEIWA Inc., thickness: 200 μm) was used as the transparent sheet in place of the PET film (DIAFOIL T-100, manufactured by Mitsubishi Chemical Corporation, thickness: 188 μm).

The evaluation results (surface resistivity and antifogging effect) of the obtained protection sheet and laminate body were the same as those in Example 6. Further, when a polycarbonate film was used as the transparent sheet, excellent transparency and impact resistance of the polycarbonate film, which are original properties of the polycarbonate film (properties of the polycarbonate film before the protection sheet was attached), were not deteriorated. These results show that the effect of the invention of the present application is achieved without deteriorating excellent transparency and impact resistance that the polycarbonate film originally has. The results also show that the effect of the invention of the present application can be achieved regardless of the material of the transparent sheet.

### Example 9

The same procedure was carried out as in Example 6 except that a biaxially stretched polypropylene film (ARPHAN E-201F, manufactured by Oji F-Tex Co., Ltd., thickness: 50 μm) was used as the base material in place of the PET film (MR, manufactured by Mitsubishi Chemical Corporation, thickness: 50 μm).

The evaluation results (surface resistivity and antifogging effect) of the obtained protection sheet and laminate body were the same as those in Example 6. These results show that even when the base material is a polypropylene film, the effect of the invention of the present application is achieved, and thus the effect of the invention of the present application can be achieved regardless of the material of the base material.

This application is based on Japanese Patent Application No. 2020-121535 filed on Jul. 15, 2020, the contents of which are incorporated in the present application.

Although the present invention has been appropriately and fully described above through the embodiments in order to express the present invention, it should be recognized that a person skilled in the art can easily modify and/or improve the above-described embodiments. Therefore, unless a change or improvement made by a person skilled in the art is at a level that departs from the scope of the claims described in the claims, the change or improvement is interpreted to be included in the scope of the claims.

### INDUSTRIAL APPLICABILITY

According to the present invention, provided is a protection sheet capable of not only protecting the transparent sheet by being attached to the transparent sheet, but also capable of making the transparent sheet into a transparent sheet which sufficiently suppresses adhesion of dust or the like and further has high antifogging properties after the protection sheet is peeled off from the transparent sheet. According to the present invention, provided is a laminate body in which a protection sheet is attached to a transparent sheet, and which can realize a transparent sheet which sufficiently suppresses adhesion of dust or the like and further has high antifogging properties after the protection sheet is peeled off.

1. A protection sheet for protecting a transparent sheet, the protection sheet comprising:
a base material having a sheet shape; and
a pressure-sensitive adhesive layer that peelably attaches the base material to the transparent sheet,
wherein the pressure-sensitive adhesive layer contains an antistatic agent.

2. The protection sheet according to claim 1, wherein the antistatic agent is at least one selected from the group consisting of an ion conductive antistatic agent and a surfactant antistatic agent.

3. The protection sheet according to claim 1, wherein the antistatic agent is a lithium ion type antistatic agent in which a lithium salt is dissolved in a silicone resin which is liquid at 25° C.

4. The protection sheet according to claim 1, wherein the pressure-sensitive adhesive layer further contains an acrylic pressure-sensitive adhesive and an isocyanate-based curing agent.

5. The protection sheet according to claim 1, wherein the base material contains at least one selected from the group consisting of polyester and polypropylene.

6. The protection sheet according to claim 1, wherein the transparent sheet is a transparent sheet that covers at least a part of a face.

7. A laminate body comprising:
the protection sheet according to claim 1; and
a transparent sheet,
wherein the protection sheet is laminated on the transparent sheet such that the pressure-sensitive adhesive layer provided in the protection sheet is in contact with the transparent sheet.

8. The laminate body according to claim 7, wherein the transparent sheet contains at least one selected from the group consisting of polyester, polycarbonate, and isosorbide polycarbonate.

9. The laminate body according to claim 7, wherein the transparent sheet covers at least a part of a face.

10. The laminate body according to claim 9, wherein the protection sheet is provided at least on a surface of the transparent sheet on a side close to the face.

11. The laminate body according to claim 9, wherein the transparent sheet is used for a face shield, a face guard, glasses, sunglasses, or goggles.
